(19) United States
(12) Patent Application Publication
(10) Pub. No.: US 2019/0312397 A1
(43) Pub. Date: Oct. 10, 2019

(54) Inline Crimper with Reconfigurable Components

(71) Applicant: Robert Bosch GmbH, Stuttgart (DE)

(72) Inventors: Robert Kochie, Dodge City, MN (US); Robert Jensen, Clarks Grove, MN (US)

(21) Appl. No.: 16/359,432

(22) Filed: Mar. 20, 2019

Related U.S. Application Data
(60) Provisional application No. 62/654,561, filed on Apr. 9, 2018.

(51) Int. Cl. H01R 43/042

(52) U.S. Cl. CPC H01R 43/042

(57) ABSTRACT

A crimping tool having a pair of jaws operable to crimp a workpiece and a number of crimping dies configured to accept a workpiece along a direction substantially parallel to the jaws. The crimping tool may comprise configurable elements for use with different types of workpieces. The crimping tool may comprise a relief channel to improve usability in difficult working environments.

### TECHNICAL FIELD

The present invention relates generally to a crimping tool. More particularly, the present invention relates to an inline crimping tool. The crimping tool may be used to crimp electrical wires.

### BACKGROUND

Vehicles such as automobiles, trucks, planes, boats and trains have wiring harnesses in them. The wiring harness provides various functions including communications, power, control and electrical connections. Wire crimping tools having a crimping portion may be used to service the wiring harness when a wire needs to be replaced or new connections made. In essence, the crimping tool is operable to remove insulations, add connectors, or to connect two or more wires together. The wiring harness, however, may be located in certain parts of the vehicle that are difficult to access. In cases where the wiring harness is difficult to reach, a crimping tool having a conventional crimping portion that crimps wires at a right angle may not work or be difficult to use to service the wiring harness. Accordingly, a crimping tool not having a right-angle interface with the wires for crimping is desirable.

### SUMMARY

One aspect of this disclosure is directed to a crimper having a first handle and a second handle, a top jaw with a top crimping surface and a bottom jaw with a bottom crimping surface in a hinged connection, and a crimping mechanism operable control the hinged connection by manipulating the first handle and the second handle. Each of the top crimping surface and bottom crimping surface may comprise a number of crimping dies configured to accept a workpiece. The crimper may further comprise a relief portion disposed between the crimping dies and the hinged connection. The bottom jaw may be detachably coupled, and operable to swap with another bottom

Another aspect of this disclosure is directed to a crimper comprising a pair of jaws aligned in a first direction and each jaw having a crimping surface. Each of the crimping surface may comprise a number of crimping dies. The crimper may further comprise a crimping mechanism controlling the relative position between the jaws, the crimping mechanism operated by a pair of handles.

The above aspects of this disclosure and other aspects will be explained in greater detail below with reference to the attached drawings.

### BRIEF DESCRIPTION OF THE DRAWINGS

FIG. 1a is a first side-view of a crimper.

FIG. 1b is a second side-view of a crimper from the opposite side depicted in FIG. 1a.

FIG. 2 is a close-up partial view of a crimper illustrating the use of the crimper with a workpiece comprising a wire.

FIG. 3 is an alternative view of a crimper illustrating the use of the crimper with a workpiece comprising a wire.

FIG. 4a-d comprise alternative views of a crimper.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

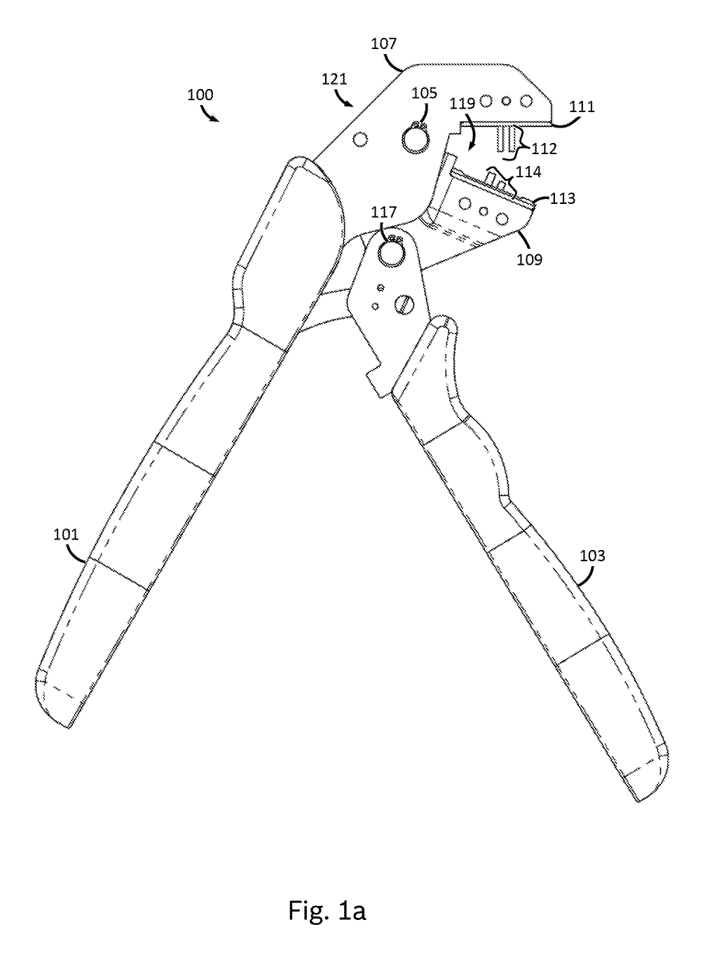

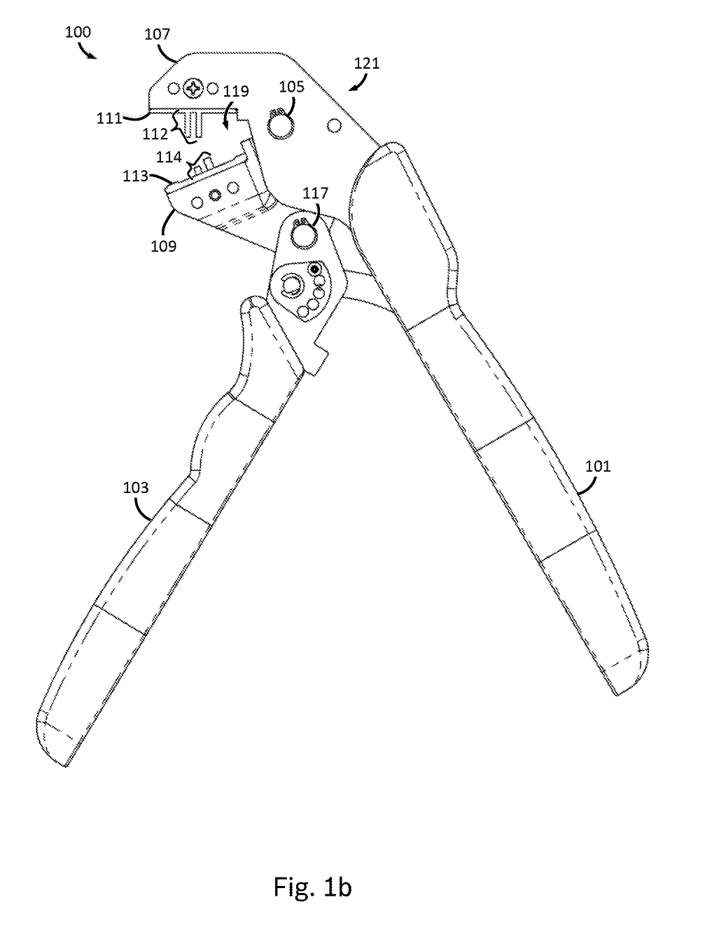

FIG. 1 shows a crimper 100 according to one embodiment of the teachings disclosed herein. Crimper 100 may be configured to accept an elongated workpiece and to crimp the workpiece. In the depicted embodiment, the workpiece may comprise a wire and the crimping may comprise adding a connector to the end of the wire, but other embodiments may comprise other configurations without deviating from the teachings disclosed herein. In some embodiments, the workpiece may comprise a tube, a cable, a pipe, a shank, or any other workpiece known to one of ordinary skill in the art. In some embodiments, crimping of the workpiece may terminate the workpiece, join a number of workpieces, provide a connector to the workpiece, remove a connector from the workpiece, or any other crimping result known to one of ordinary skill in the art without deviating from the teachings disclosed herein.

Crimper 100 comprises a first handle 101 and a second handle 103, which may be operated in coordination to control a crimping mechanism 105. Crimping mechanism 105 may be operable to control the relative distance between a top jaw 107 and a bottom jaw 109 of crimper 100 during a crimping operation. In the depicted embodiment, crimping mechanism is a hinged coupling between top jaw 107 an bottom jaw 109, but other embodiments may comprise other configurations without deviating from the teachings disclosed herein. Top jaw 107 may comprise a top proximal end that couples to one or more of the handles or crimping mechanism 105 and a top distal end extending away from the top proximal end that is free of coupling to other portions of crimper 100. Bottom jaw 109 may comprise a bottom proximal end that couples to one or more of the handles or crimping mechanism 105 and a bottom distal end extending away from the bottom proximal end that is free of coupling to other portions of crimper 100. The extensions of the top distal end and the bottom distal end may be in alignment to accept a workpiece for crimping.

In the depicted embodiment, top jaw 107 comprises a top crimping surface 111 having a number of top crimp dies 112 disposed therein. In the depicted embodiment, bottom jaw 109 comprises a bottom crimping surface 113 having a number of bottom crimp dies 114 disposed thereon. Top crimping dies 112 and bottom crimping dies 114 are operable to provide a crimping action when crimping mechanism 105 controls the relative distance of top jaw 107 and bottom jaw 109. In the depicted embodiment, the crimping action may be controlled by first handle 101 and second handle 103, each of which are operably coupled to crimping mechanism 105 via a handle coupling mechanism 117. In the depicted embodiment, handle coupling mechanism 117 comprises a hinge, but other embodiments may comprise other configurations without deviating from the teachings disclosed herein. Some embodiments may not comprise handle coupling mechanism 117, and instead may comprise handles having a direct coupling to crimping mechanism 105.

Top crimping dies 112 and bottom crimping dies 114 may be oriented to provide a crimping action when the workpiece is inserted in a direction substantially parallel to the length of top jaw 107 and bottom jaw 109. Throughout this disclosure, “substantially parallel” or “substantially perpendicular” refers to angles that are respectively parallel or perpendicular within a specified tolerance. The tolerance may be determined based upon manufacturing limitation or functional requirements of crimper 100. The workpiece is inserted in a manner substantially parallel, or “in-line”, to the jaws and may advantageously permit utilization of crimper 100 in conditions where conventional perpendicular crimping tools are difficult or impossible to use.

The depicted embodiment comprises two top crimping dies 112 and two bottom crimping dies 114. Other embodiments may comprise a different number of top crimping dies 112 or bottom crimping dies 114 without deviating from the teachings disclosed herein. In some embodiments, one or both of top crimping dies 112 or bottom crimping dies 114 may comprise a different configuration than the depicted embodiment without deviating from the teachings disclosed herein. In some embodiments, one or both of top crimping dies 112 or bottom crimping dies 114 may be disposed upon a respective crimping surface, but other embodiments may comprise alternative configurations without deviating from the teachings disclosed herein. In some embodiments, one or both of top crimping dies 112 or bottom crimping dies 114 may be disposed directly upon a top jaw 107 or bottom jaw 109 respectively without a respective crimping surface without deviating from the teachings disclosed herein. In some embodiments, one or both of crimping dies 112 or bottom crimping dies 114 may be formed by a respective jaw or crimping surface directly, rather than disposed upon or coupled to the respective jaw or crimping surface without deviating from the teachings disclosed herein.

In the depicted embodiment, a relief portion 119 is disposed behind the top crimping dies 112 and bottom crimping dies 114. Relief portion 119 may provide a location for the workpiece to slack, additional extension, or overflow beyond the crimping dies during a crimping action. In the depicted embodiment, relief portion 119 leads to a relief channel 121 providing a portal from the crimping dies to behind the operable components of the jaws. Relief channel 121 may operably permit passage of an elongated workpiece for feeding into the jaws of crimper 100 from behind the proximal ends of the jaws, which may advantageously allow a user to observe a crimping action visually in workspaces that are otherwise difficult to maneuver. Some embodiments may not comprise one or more of relief portion 119 or relief channel 121 without deviating from the teachings disclosed herein.

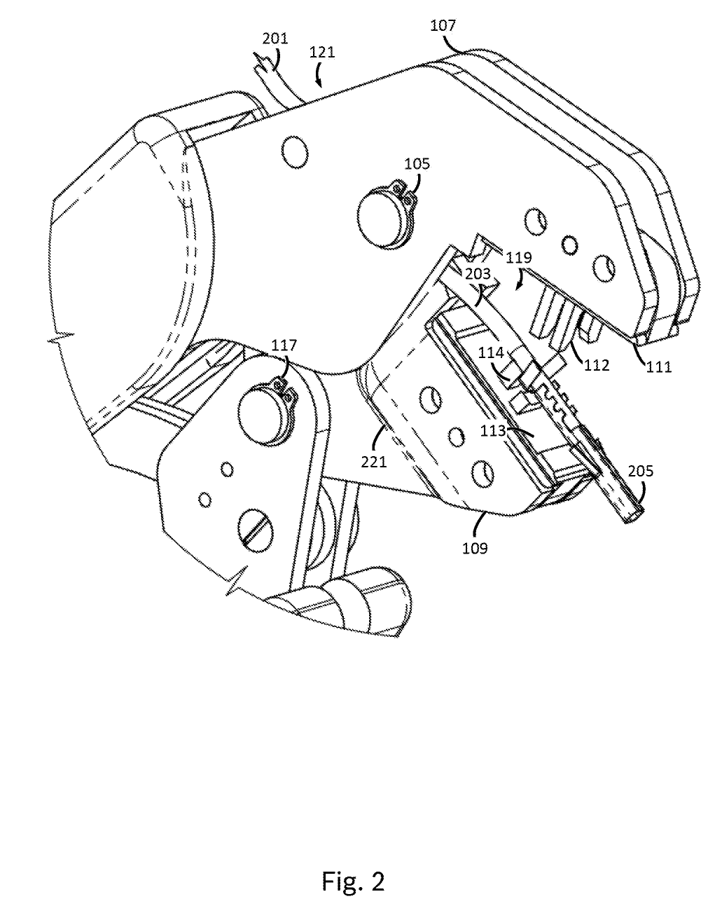

FIG. 2 depicts a close-up view of the crimper 100 during a crimping action that utilizes relief channel 121. The depicted embodiment, the workpiece comprises a wire having a wire feed portion 201 extending toward a wire terminus portion 203, but other embodiments may comprise other configurations without deviating from the teachings disclosed herein. In the depicted embodiment, the wire is subjected to a crimping action for the purpose of coupling a connector 205 to the wire terminus portion 203. The wire is fed through relief channel 121 such that the wire terminus portion 203 is received by top crimping dies 112 and bottom crimping dies 114 and fitted with connector 205, while the wire feed portion 201 comprising a portion of the remaining length of the wire passes through relief channel 121 and relief portion 119.

In some embodiments, one or more of the top jaw 107 or bottom jaw 109 may he reconfigurable to accommodate a wider variety of workpieces. For example, one or more of top crimping dies 112, bottom crimping dies 114, top crimping surface 111, bottom crimping surface 113, top jaw 107 or bottom jaw 109 may be detachably coupled and operable to be swapped with an alternative component configured for use with a workpiece of a different specification. In the depicted embodiment, bottom jaw 109 may comprise a first bottom jaw having a first configuration for a first wire gauge that may be swapped with a second bottom jaw having a second configuration for a second wire gauge different than the first wire gauge. In the depicted embodiment, bottom jaw 109 may be detachably coupled to crimper 100 along a detachable contour 221, but other embodiment may comprise other configurations without deviating from the teachings disclosed herein. In some embodiments, bottom jaw 109 may be detachable using a latching mechanism, a hook mechanism, a nut-and-bolt, a screw, a sliding interlock mechanism, or any other detachable coupling mechanism understood by one of ordinary skill in the art without deviating from the teachings disclosed herein. In some embodiments, top jaw 109 may be detachable using a detachable contour, a latching mechanism, a hook mechanism, a nut-and-bolt, a screw, a sliding interlock mechanism, or any other detachable coupling mechanism understood by one of ordinary skill in the art without deviating from the teachings disclosed herein. In some embodiments, bottom crimping surface 113 may be detachable instead of, or in addition to, bottom jaw 109 and using a sliding interlock mechanism, a screw, a nut-and-bolt, a hook mechanism, a latching mechanism, or any other detachable coupling mechanism understood by one of ordinary skill in the art without deviating from the teachings disclosed herein. In some embodiments, top crimping surface 111 may be detachable instead of, or in addition to, top jaw 107 and using a sliding interlock mechanism, a screw, a nut-and-bolt, a hook mechanism, a latching mechanism, or any other detachable coupling mechanism understood by one of ordinary skill in the art without deviating from the teachings disclosed herein. Detachable components of crimper 100 may advantageously provide compatibility with a wider variety of workpieces, or may additionally provide field servicing options to crimper 100.

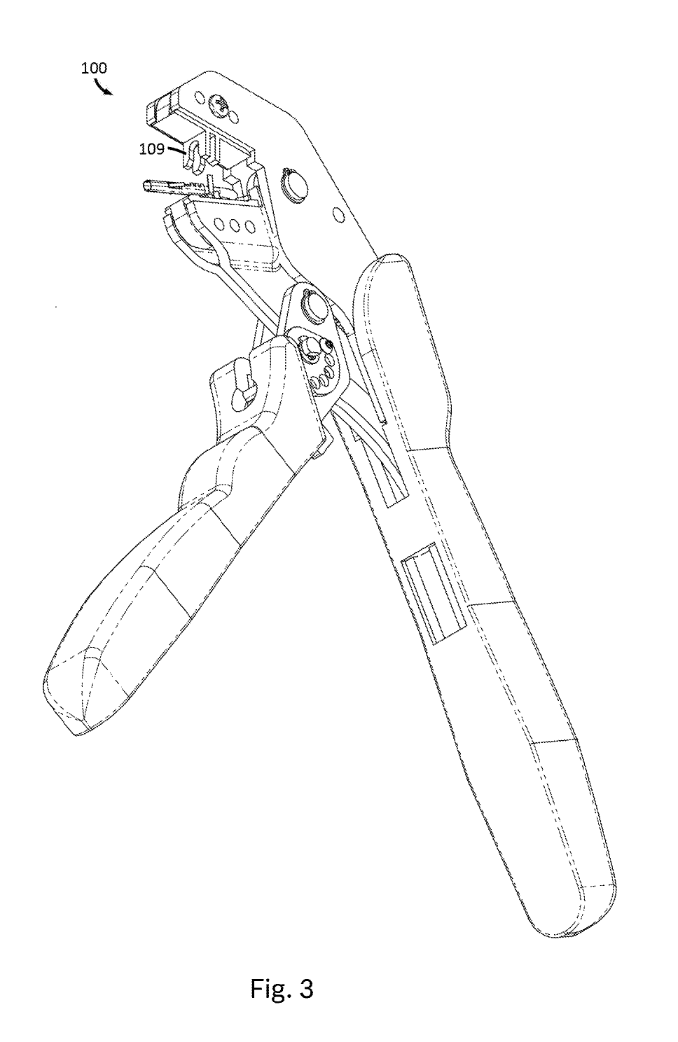

FIG. 3 depicts an alternate view of one embodiment of crimper 100, including an alternative angle depicting top crimping dies 109. Other embodiments may comprise other configurations of top crimping dies 109 without deviating from the teachings disclosed herein.

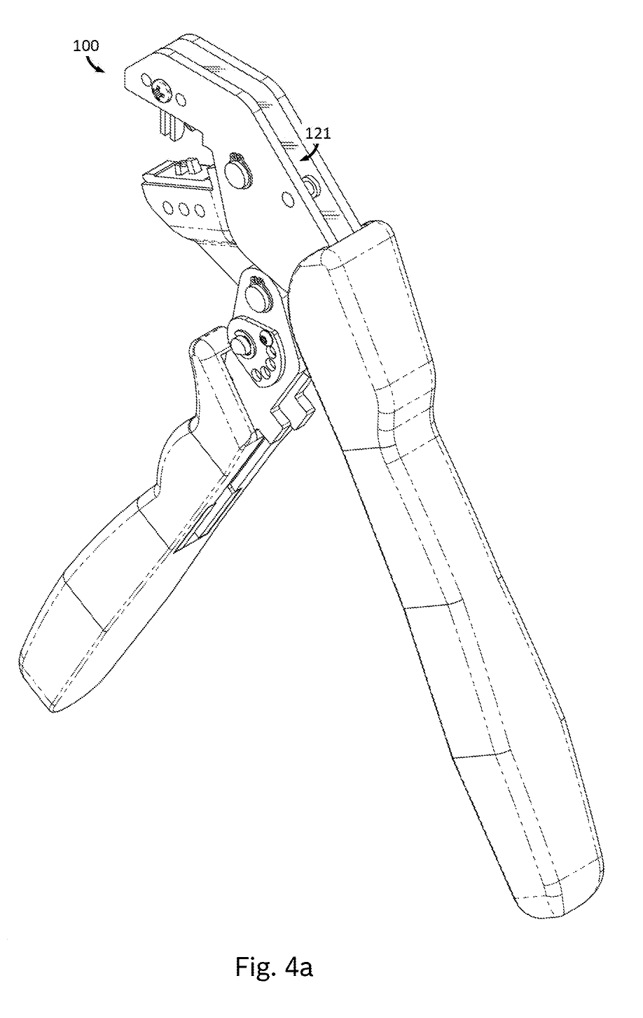

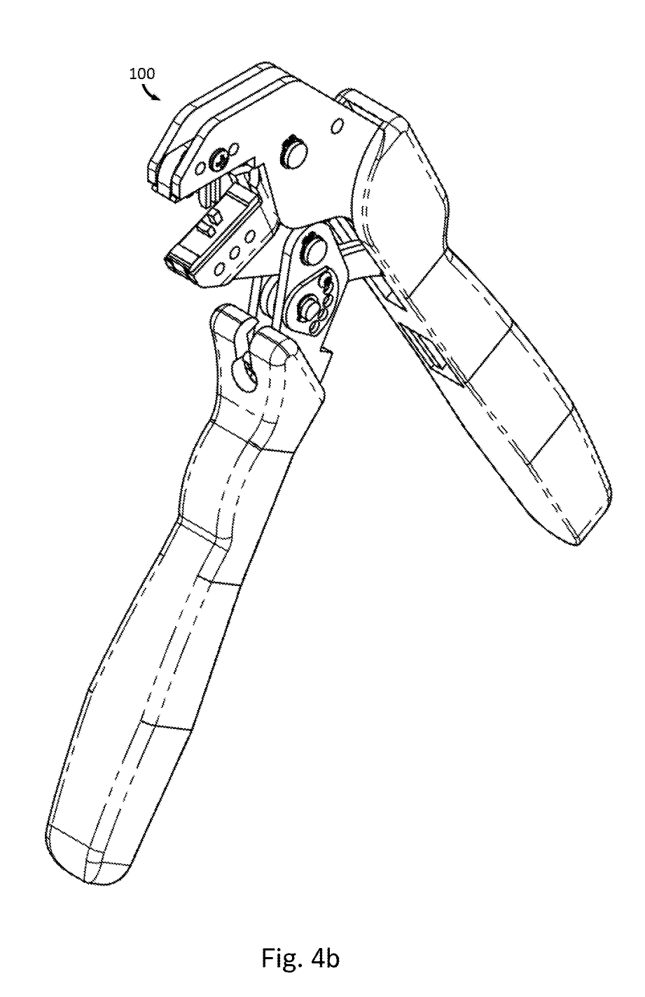

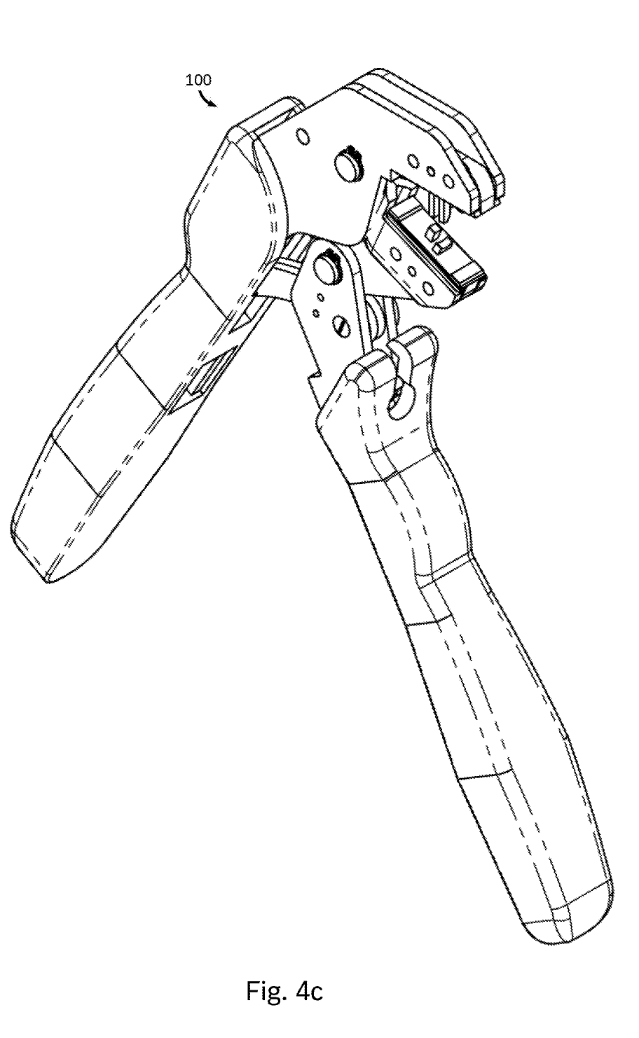

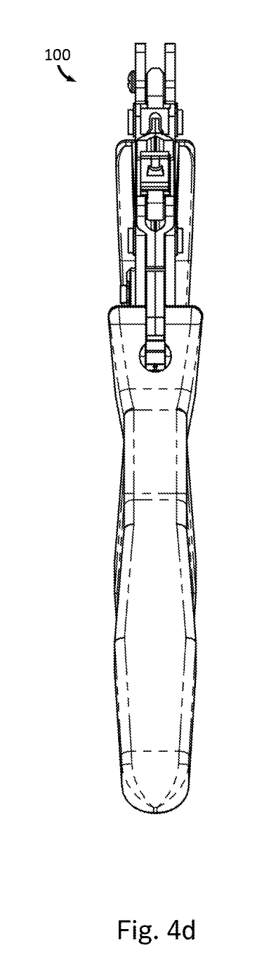

FIG. 4 depicts alternate views of one embodiment of crimper 100 from a variety of angles. FIG. 4a provides a particular view of relief channel 121 according to this embodiment. Other embodiments may comprise alternative configurations without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form farther embodiments of the disclosed concepts.

What is claimed is:

1. A crimper comprising:
a first handle;
a top jaw having a top proximal end disposed upon the first handle and a top distal end extending away from the first handle in a first direction, the top jaw further having, a top crimping surface disposed between the top proximal end and the top distal end;
a bottom jaw having a bottom proximal end disposed in a hinged connection to the top jaw and a bottom distal end extending substantially along the first direction, the bottom jaw further having a bottom crimping surface disposed between the bottom proximal end and the bottom distal end and opposed to the top crimping surface and movable relative to the top crimping surface;
a number of top crimping dies disposed upon the top crimping surface operable to receive elongated workpiece oriented substantially along the first direction;
a number of bottom crimping dies disposed upon the bottom crimping surface operable to receive a wire oriented substantially along the first direction and cooperate with the top crimping dies to crimp the wire;
a crimping mechanism operably coupled to the hinged connection to control a relative position between the top crimping surface and the bottom crimping surface; and
a second handle operably coupled to the crimping mechanism to control the crimping mechanism, wherein the first handle and the second handle are substantially disposed within a plane defined in part by the first direction.

2. The crimper of claim 1, wherein the top jaw further defines a relief portion between the top crimping dies and the top proximal end, the relief portion operable to receive a portion of the workpiece other than a portion of the workpiece to be crimped.

3. The crimper of claim 2, wherein the relief portion comprises a channel defined by the top jaw and disposed between the top proximal end and the top crimping dies.

4. The crimper of claim 1, wherein the bottom crimping dies are configured to crimp a wire of a first gauge.

5. The wire crimper of claim 4, wherein the bottom jaw is a first bottom jaw that is operable to be swapped with a second bottom jaw comprising second bottom crimping dies configured to crimp wire of a second gauge.

6. The crimper of claim 5, wherein the second gauge is different from the first gauge.

7. The crimper of claim 1, wherein the crimp mechanism is connected to the second handle via a second hinged connection.

8. The crimper of claim 1, wherein one of the top crimping surface or bottom crimping surface is detachably coupled to its respective jaw.

9. The crimper of claim 8, wherein the detachably coupled crimping surface is configured to crimp a wire having a particular gauge.

10. A crimper comprising:
a pair of jaws comprising a top jaw and a bottom jaw, the pair of jaws aligned in a first direction and each jaw comprising a crimping surface having a number of crimping dies disposed thereon, the crimping surface of the top jaw movable relative to the crimping surface of the bottom jaw;
a crimping mechanism operably coupled to each jaw of the pair of jaws and operable to control the relative position between the respective crimping surfaces of the top jaw and the bottom jaw; and
a pair of handles, each handle operably coupled to the crimping mechanism and operable to control the crimping mechanism, wherein the crimping dies are configured to receive an elongated workpiece along the first direction and to crimp the received workpiece.

11. The crimper of claim 10, wherein the crimping dies are configured to receive a workpiece comprising a wire, the bottom jaw comprises a crimping die configured for a particular wire gauge and the bottom jaw is detachably coupled to the pair of jaws.
